(19) United States
(12) Patent Application Publication
(10) Pub. No.: US 2025/0088835 A1
(43) Pub. Date: Mar. 13, 2025

(54) Direct Acquisition of UWB Ranging Triggers Over Bluetooth Including Power Boosting of Bluetooth Signals

(71) Applicant: Apple Inc., CUPERTINO, CA (US)

(72) Inventors: Vignesh Babu MOORTHY, San Jose, CA (US); Nischay GOEL, San Jose, CA (US); Yann LY-GAGNON, San Francisco, CA (US)

(21) Appl. No.: 18/826,630

(22) Filed: Sep. 6, 2024

Related U.S. Application Data
(60) Provisional application No. 63/581,561, filed on Sep. 8, 2023.

(51) Int. Cl. H04W 8/00; H04B 1/7163; H04W 28/02; H04W 64/00

(52) U.S. Cl. CPC H04W 8/005; H04B 1/7163; H04W 28/0284; H04W 64/00

(57) ABSTRACT

An apparatus configured to initiate an operation to locate a target device, determine one or more metrics related to Bluetooth congestion, determine transmission parameters for a Bluetooth discovery operation based on the one or more metrics, generate, for transmission, Bluetooth discovery signals with the determined transmission parameters and trigger an ultra-wideband (UWB) ranging operation when a Bluetooth discovery response from the target device is detected.

### PRIORITY/INCORPORATION BY REFERENCE

This application claims priority to U.S. Provisional Application Ser. No. 63/581,561 filed on Sep. 8, 2023, entitled “Direct Acquisition of UWB Ranging Triggers Over Bluetooth Including Power Boosting of Bluetooth Signals,” the entirety of which is incorporated by reference herein.

### BACKGROUND

A user equipment (UE) may be equipped with mechanisms for locating another device, e.g., determining the range of the other device relative to the UE. For example, the UE may use a short-range protocol such as Bluetooth or ultra-wideband (UWB). In some cases, Bluetooth may be used as a discovery mechanism to detect the proximity of the other device and this proximity detection can trigger the UWB mechanism for precisely locating the other device. However, in some deployment scenarios, e.g., congested environments such as concerts, theme parks, or crowded cities, the ranging performance can be suppressed due to Bluetooth interference.

### SUMMARY

Some example embodiments are related to an apparatus having processing circuitry configured to initiate an operation to locate a target device, determine one or more metrics related to Bluetooth congestion, determine transmission parameters for a Bluetooth discovery operation based on the one or more metrics, generate, for transmission, Bluetooth discovery signals with the determined transmission parameters and trigger an ultra-wideband (UWB) ranging operation when a Bluetooth discovery response from the target device is detected.

Other example embodiments are related to an apparatus having processing circuitry configured to initiate an operation to locate a target device, determine whether cellular or wireless network coverage is available, when cellular or wireless network coverage is available, generate, for transmission at a first transmit power, Bluetooth discovery signals, when cellular or wireless network coverage is not available, generate, for transmission at a second transmit power, the Bluetooth discovery signals, wherein the second transmit power is greater than the first transmit power and trigger an ultrawideband (UWB) ranging operation when a Bluetooth discovery response from the target device is detected.

### BRIEF DESCRIPTION OF THE DRAWINGS

FIG. 1 shows a diagram for an ultra-wideband (UWB) ranging mechanism with a Bluetooth discovery mechanism and a narrowband assist according to existing techniques.

FIG. 2 shows a diagram for an ultra-wideband (UWB) ranging mechanism with both a Bluetooth discovery trigger and an Internet-based discovery trigger according to various example embodiments.

FIG. 3 shows a signaling diagram for a location determining mechanism comprising ultra-wideband (UWB) ranging with both a Bluetooth discovery trigger and an Internet-based discovery trigger according to various example embodiments.

FIG. 4a shows a plot comprising a line of sight (LoS) link budget time series for Bluetooth channels.

FIG. 4b shows a plot comprising a no-LoS (nLoS) link budget time series for Bluetooth channels.

FIG. 5 shows a flowchart for selecting Bluetooth operating parameters for a discovery mechanism to trigger UWB ranging according to various example embodiments.

FIG. 6 shows an example arrangement according to various example embodiments.

FIG. 7 shows an example user equipment (UE) according to various example embodiments.

### DETAILED DESCRIPTION

The example embodiments may be further understood with reference to the following description and the related appended drawings, wherein like elements are provided with the same reference numerals. The example embodiments relate to discovery mechanisms for triggering an ultra-wideband (UWB) ranging operation.

The example embodiments are described with regard to a user equipment (UE). However, reference to a UE is merely provided for illustrative purposes. The example embodiments may be utilized with any electronic component that is equipped with the hardware, software, and/or firmware to wirelessly exchange signals with a network and/or another remote device. Therefore, the UE as described herein is used to represent any electronic component.

The example embodiments are also described with regard to a UE enabled for establishing radio links using short-range wireless communication protocols. Bluetooth (e.g., Bluetooth, Bluetooth Low-Energy (BLE), etc.) is a type of communication protocol that enables short-range communication between two or more devices. Some use cases for Bluetooth include ranging (or location determining) applications in which the location of the target device is estimated based on channel measurements such as received signal strength indicator (RSSI), wherein the finder device measures the strength of a signal from the target device to estimate the distance between the devices. Bluetooth operates in the 2.4 GHz industrial scientific and medical (ISM) spectrum band.

Ultra-wideband (UWB) is another type of communication protocol that enables short-range communication between two or more devices. Some use cases for UWB include location determining or ranging applications in which the location of the target device is estimated by transmitting a large number of pulses quickly (e.g., at a multi-millisecond (MMS) rate) across a wide spectrum. The finder device determines the range of the target device based on time difference of arrival (TDOA) or time of flight (ToF) measurements. UWB technology is capable of making range determinations with a high degree of precision, e.g., 10 cm. UWB operates across a spectrum range greater than 7 GHz (from 3.1 GHz to 10.6 GHz). In some cases, the UWB ranging mechanism can comprise a narrowband (NB) assist prior to the UWB session.

In some cases, Bluetooth may be used as a discovery mechanism to detect the proximity of the other device, where this proximity detection can trigger the UWB mechanism for precisely locating the other device. Generally, Bluetooth has better propagation than UWB (2.4 GHz vs. 5.7 GHz) and less noise (1 MHz bandwidth vs. 3 MHz bandwidth for UWB-NB) and thus should be capable of detecting the proximity of the device within a range greater than the UWB operating range. According to existing techniques, a first device (e.g., finder device) can locate a second device (e.g., target device) via UWB ranging triggered by Bluetooth discovery.

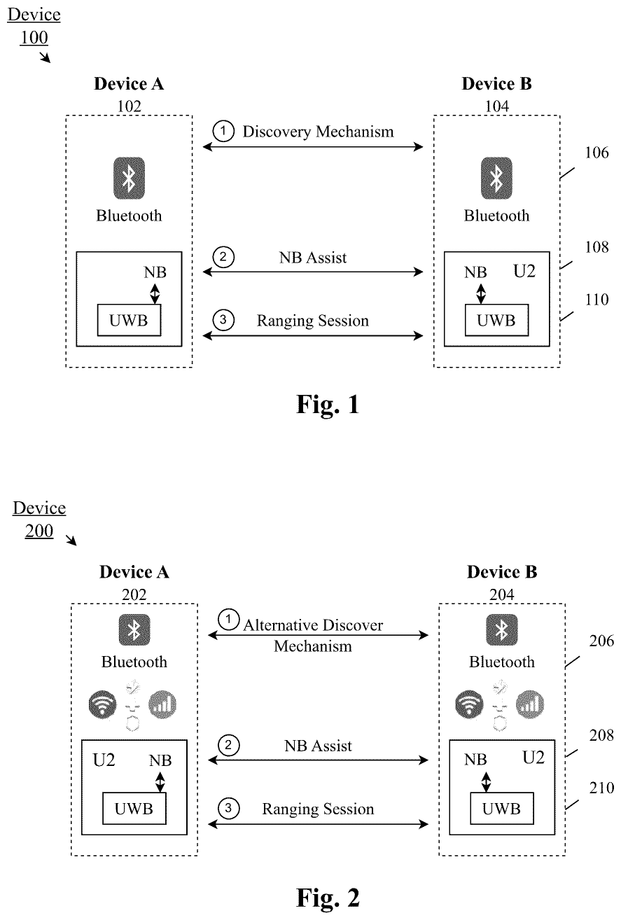

FIG. 1 shows a diagram 100 for a UWB ranging mechanism with a Bluetooth discovery mechanism and a narrowband assist according to existing techniques. The diagram 100 includes a first device (Device A) 102 and a second device (Device B) 104. The first device 102 can initiate an operation to locate the second device 104 in various scenarios. In one example, in a crowded environment, a user of the first device 102 may seek to locate a user of the second device 104 and execute an application for finding the location of the second device 104. In a first phase 106, the first device 102 can transmit Bluetooth discovery signals, e.g., advertisements, and listen for a response. When the second device 104 detects the discovery signal, the second device 104 can transmit a Bluetooth discovery response, e.g., advertisement. When the first device 102 receives the discovery response this can trigger the first device 102 to perform UWB ranging on a U2 antenna (or any other type of antenna). In a second phase 108, the operation can comprise a narrowband assisted discovery prior to a third phase 110 comprising the UWB ranging session.

UWB ranging can show improved performance relative to Bluetooth ranging. However, UWB is also more complicated and energy intensive than Bluetooth. The U2 antenna for performing UWB ranging should not always be on. In many cases, it is preferable to perform UWB ranging only if it is first determined that the finder device and the target device are in a general proximity to one another. Accordingly, it may be preferable to have the triggering mechanism as a precondition for UWB ranging, e.g., as described above. However, it has been observed that Bluetooth-gated UWB has a degraded operating range in certain congested environments, e.g., crowded outdoor locations, theme parks, or malls. In these cases, the Bluetooth range may be degraded and may trigger the UWB ranging only within ranges less than the UWB operating range, thus limiting the UWB range.

According to the present example embodiments, enhancements are described for triggering the UWB ranging mechanism. In some example embodiments, an alternative Internet-based discovery method can trigger the UWB ranging. In some example embodiments, the alternative Internet-based discovery method can be used in parallel with a Bluetooth discovery method. In some example embodiments, the Bluetooth discovery method can be enhanced under certain conditions, e.g., congested environments or when the Internet-based discovery method is not available.

In one aspect of these example embodiments, an alternative discovery mechanism can be used to trigger UWB ranging. The alternative discovery mechanism may be deployed over the Internet. The alternative Internet-based discovery mechanism may be referred to herein as an Internet Discovery Service (IDS). In these embodiments, a message is sent from the finder device to the target device (or findee device) and, if the finder device receives a response from the target device, UWB ranging is triggered at the target device.

In some example embodiments, the Internet-based discovery mechanism can be used in combination with the Bluetooth-based discovery method. For example, both discovery mechanisms can be initiated in parallel and, if either of them is successful, the UWB ranging is triggered.

FIG. 2 shows a diagram 200 for an ultra-wideband (UWB) ranging mechanism with both a Bluetooth discovery trigger and an Internet-based discovery trigger according to various example embodiments. The diagram includes a first device 202 (Device A) and a second device 204 (Device B). The first device 202 can initiate an operation to locate the second device 204. In a first phase 206, the first device 202 can transmit Bluetooth discovery signals and Internet-based discovery messages in parallel and listen for a response. When the second device 204 detects either discovery signal, the second device 204 may transmit a discovery response via either or both the Bluetooth discovery mechanism and/or the Internet-based discovery mechanism. When the first device 202 receives either discovery response this can trigger the first device 202 to perform UWB ranging on the U2 antenna. In a second phase 208, the operation can comprise a narrowband assisted discovery prior to a third phase 210 comprising the UWB ranging session.

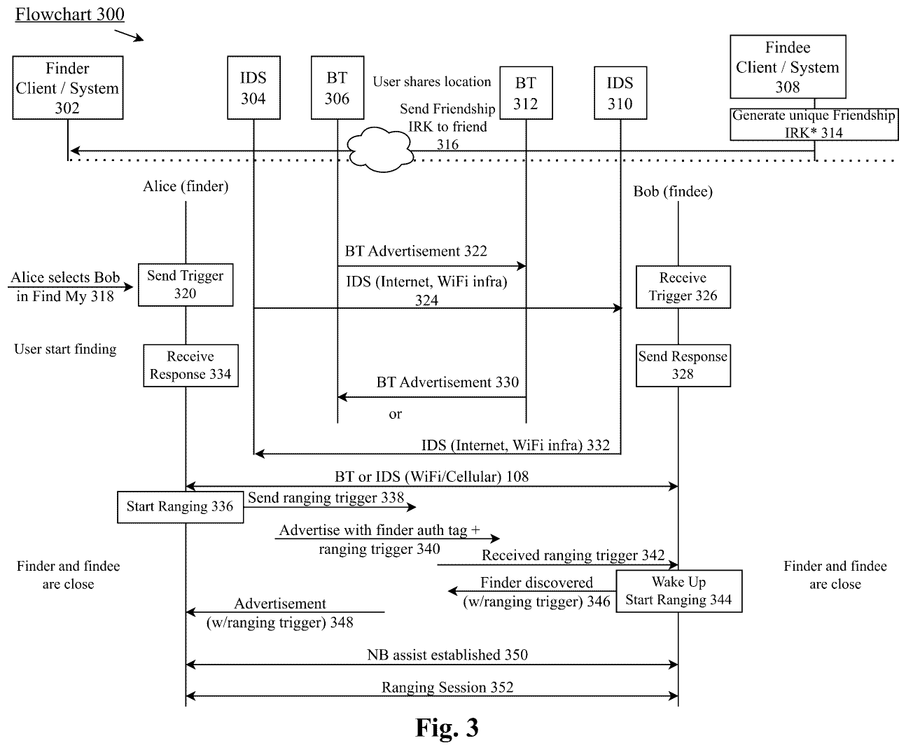

FIG. 3 shows a signaling diagram 300 for a location determining mechanism comprising UWB ranging with both a Bluetooth discovery trigger and an Internet-based discovery trigger according to various example embodiments. The signaling diagram 300 includes a finder 302, which may be a device (client) or a system. The finder 302 includes an IDS module 304 or subsystem and a Bluetooth module 306 or subsystem. The signaling diagram 300 further includes a findee 308, which may be a device (client) or a system. The findee 308 may be referred to as a target device. The findee 308 includes an IDS module 310 or subsystem and a Bluetooth module 312 or subsystem.

In 314, the finder 302 and the findee 308 can generate and exchange unique friendship keys, e.g., identity resolving keys (IRK), to enable these devices/systems to locate each other. In this example, the finder 302 uses the unique IRK from the findee 308 to enable the finder 302 to locate the findee 308. In 316, the findee 308 transmits the unique keys to the finder 302. In this example, the finder 302 may be associated with a first user (Alice) and the findee 308 may be associated with a second user (Bob).

In 318, the finder 302 initiates an operation to locate the findee 308. In one example, the finder 302 (Alice) may execute an application, e.g., a “Find My” application, and select the findee 308, e.g., by selecting the name (Bob) associated with the findee 308 device.

In 320, the finder 302 sends the Bluetooth-based ranging trigger 322 and the IDS-based ranging trigger 324 in parallel. The BT trigger 322 comprises a BT discovery signal, e.g., advertisement. The IDS trigger 324 comprises a message sent over the Internet. Thus, in this example, the finder 302 has Internet access via, e.g., a cellular network or another wireless network such as a wireless local area network (WLAN) or a wide area network (WAN).

In 326, the findee 308 receives either one or both of the BT ranging trigger 322 or the IDS ranging trigger 324. The receipt of only one of the two ranging triggers is sufficient to trigger a response by the findee 308. In one example, if the findee 308 is in a BT congested environment, the BT ranging trigger 322 may not be detected and, if the findee 308 has Internet access, only the IDS trigger 324 may be received. In another example, if the findee 308 has no cellular access or poor wireless network coverage, the IDS ranging trigger 324 may not be received and, if BT coverage is sufficient, only the BT trigger 322 may be received.

In 328, the findee 308 sends either one or both of a BT ranging response 330 and/or an IDS ranging response 332. In one example, the findee 308 may send both types of response regardless of which ranging trigger was received. In another example, the findee 308 may send a response via whichever mechanism by which the findee 308 received the trigger.

In 334, the finder 302 receives either one or both of the ranging responses 330, 332. When the response is received, it may be established that the finder 302 and the findee 308 are sufficiently close to trigger the UWB ranging mechanism.

In 336, the finder 302 initiates the UWB ranging mechanism. The UWB ranging mechanism generally comprises the finder 302 waking up its UWB chipset, sending a ranging trigger (338) and advertising with a finder authorization tag with the ranging trigger (340) and the findee 308 receiving the ranging trigger (342). When the ranging trigger is received, the findee 308 can wake up its UWB chipset (344), transmit the ranging trigger (346) and transmit an advertisement with the ranging trigger (348). The narrowband assist is then established (350) and the UWB ranging session (352) can begin.

As described above, the BT trigger and the IDS trigger can be used in parallel by both the finder device and the target device. In other example embodiments, only the IDS trigger mechanism may be used if, for example, a congested BT environment is detected. The IDS trigger mechanism can be supported by a mobile device such as mobile phone, a cellular watch, or a watch with Wi-Fi.

In some example embodiments, no preconditions are imposed for using the IDS trigger, e.g., the only requirement for initiating the Internet discovery mechanism is the finder device having Internet access via, e.g., a cellular network or a Wi-fi network. If the target device also has Internet access then the message can be received at the target device. A response can then be sent to the finder device that, upon receipt by the target device, can trigger the UWB ranging.

In other example embodiments, the Internet discovery mechanism may be used if certain preconditions are met. In one example, a precondition may be imposed wherein the IDS trigger mechanism is used if the finder device and the target device are in a general proximity of one another.

In some example embodiments, GPS proximity may be a precondition to sending the Internet discovery message. In one example, the finder device may be tracking or have previously tracked the GPS location of the target device. The finder device can compare its current GPS location to a current or most recent GPS location. If the current GPS location of the finder is within a predefined range of the findee, then the IDS message can be sent. In another example, the target device may be tracking or have previously tracked the GPS location of the finder device. After receiving the Internet discovery message, the target device can compare its current GPS location to a current or most recent GPS location of the finder device. If the current GPS location of the findee is within a predefined range of the finder, then the IDS response can be sent. If the GPS location for either the finder or the findee is not up to date, a previous GPS location can be checked.

There are some locations or events with both poor Bluetooth performance and poor cellular performance. In some cases, the alternative Internet-based discovery mechanism may be unavailable. In one example, some finder devices and/or findee devices may not have Internet access or may not be capable of Internet access. Thus, only the Bluetooth trigger may be available.

In another aspect of these example embodiments, the Bluetooth trigger mechanism can be performed with different operating parameters based on an analysis of Bluetooth-related metrics. In some embodiments, the operating parameters for the Bluetooth discovery operation can include a transmit power, a data rate, antenna diversity, and/or a ranging interval that can be adjusted based on the Bluetooth environment. The Bluetooth environment can be analyzed based on metrics including Bluetooth density and visibility.

The operating parameters for the Bluetooth trigger operation can comprise default parameters under non-congested conditions. For example, under non-congested conditions, the Bluetooth operating parameters can comprise a transmit power of 7.5 dBm, no antenna diversity (antenna diversity disabled), a data rate of 2 Mbps, and a ranging interval of 10 ms. The above default values are provided as an example only and other default values can be defined. If a strong BT signal is detected, the default parameters can be used.

When various degrees of congestion are detected, the Bluetooth operating parameters can be adjusted to improve the performance of the Bluetooth operation, e.g., increase the operating range. In one example, the transmit power can be boosted to a higher level while remaining within regulatory limits, which may depend on the country in which the UE is located, to increase the BT operating range. In the United States, the transmit power can be boosted from the default value of 7.5 dBm to 16.5 dBm and, in the United Kingdom, the transmit power can be boosted from the default value of 7.5 dBm to 14.5 dBm. In another example, antenna diversity can be enabled to increase the BT operating range. In another example, the data rate can be lowered from the default value of 2 Mbps to, e.g., 1 Mbps or 256 kbps, to increase the operating range. In another example, the ranging interval can be increased to, e.g., 15 ms, 30 ms, 120 ms, etc.

The degree of Bluetooth congestion can be analyzed based on various metrics determinable by the UE. In one embodiment, a crowd density can be estimated by locally scanning a number of Bluetooth devices. In one example, a crowd density less than 100 Bluetooth devices can indicate a non-congested environment. In another example, a crowd density of 250 Bluetooth devices can indicate a moderately congested environment. In still another example, a crowd density of greater than 500 devices can indicate a highly congested environment. The number of Bluetooth devices indicating various levels of congestion described above is an example and different numbers of Bluetooth devices in the vicinity of the UE can be interpreted in various ways in combination with other metrics.

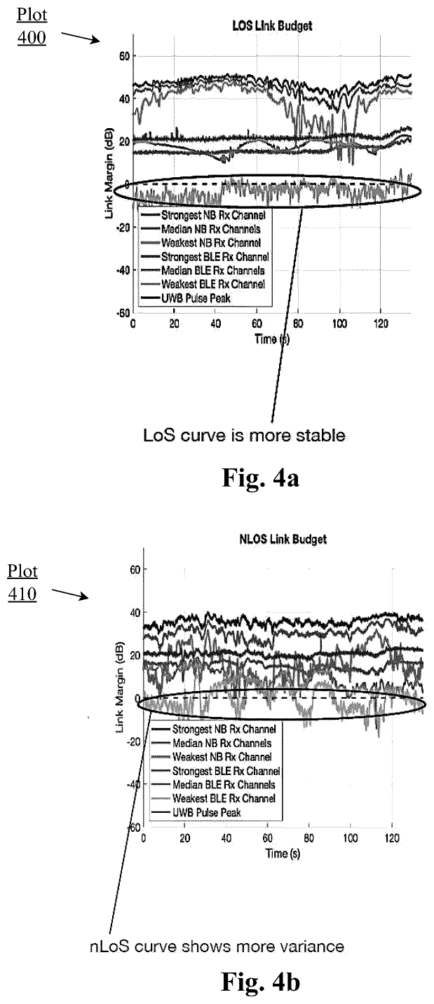

In another example embodiment, visibility can be detected based on analyzing a line of sight (LoS) and/or no line of sight (nLoS) link budget. In one example, the shape of the link margin time series can be analyzed. FIG. 4a shows a plot 400 comprising a Los link budget time series. In this example, the LoS curve is stable which can indicate that the default values may be acceptable. FIG. 4b shows a plot 410 comprising a nLoS link budget time series. In this example, the nLoS curve shows some variance which can indicate that boosted values should be used.

The decision making process can consider the crowd density, visibility, and maximum allowable BT transmit power (in view of regulatory limits) when selecting the operating parameters for BT discovery. The BT-related metrics can indicate that certain parameters should be adjusted while other parameters can remain at their default values.

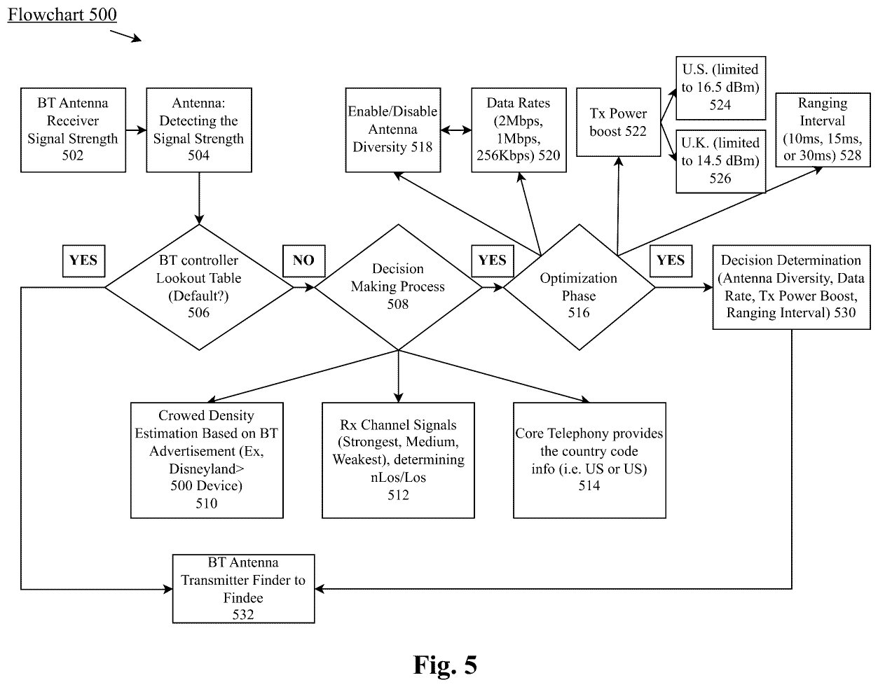

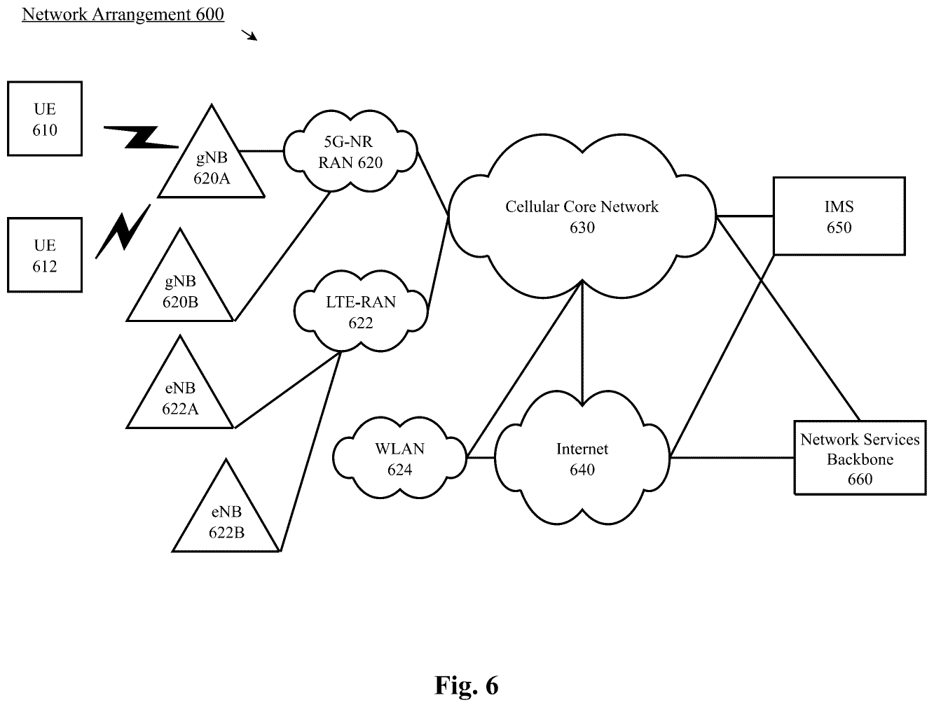

FIG. 5 shows a flowchart 500 for selecting Bluetooth operating parameters for a discovery mechanism to trigger UWB ranging according to various example embodiments. In 502, the UE measures the Bluetooth signal strength. In 504, the UE detects the Bluetooth signal strength. In 506, the BT controller of the UE checks the BT signal strength against a lookup table to determine if the default operating parameters can be used for BT discovery. If the signal strength is sufficient, the BT controller initiates the BT discovery process with default values (532). If the signal strength is not sufficient, in 508, the UE initiates a decision making process for adjusting the BT operating parameters.

In 510, the UE estimates the crowd density by locally scanning a number of BT devices based on BT advertisement transmission/response. In 512, the UE measures BT receive channels to determine a link margin over time for LoS and nLoS. In 514, the UE checks the core telephony for a country code, e.g., US or UK.

Based on the decision making process of 508, the UE, in 516, performs an optimization process for adjusting operating parameters for BT discovery. In 518, the UE considers enabling or disabling antenna diversity. In 520, the UE considers a data rate. In 522, the UE considers a BT transmit power which can be boosted to 16.5 dBm in some countries (524) or 14.5 in other countries (526). In 528, the UE considers a ranging interval.

In 530, the UE determines the BT operating parameters for discovery. In 532, the UE transmits discovery signals.

With regard to the optimization process described above in 516, it is noted that this process may vary depending on the types of devices involved in the ranging process (e.g., mobile phone, watch, other types of peripheral devices). In one example embodiment, when the finder device and the target device are both mobile phones, only the Tx power may be adjusted (within regulatory limits) to boost the operating range. Antenna diversity may remain disabled, and the data rate and ranging interval may remain at their default values.

In another example embodiment, when one or both of the finder device and target device have no cellular connectivity (e.g., in locations with poor cellular coverage or if the device is a watch or other peripheral device with no cellular capabilities), and particularly when a maximum Tx power is 14.5 dBm (based on regulatory limits), the data rate can be decreased to increase the Bluetooth operating range. For example, a data rate of 256 kbps or 1 Mbps can be used (e.g., based on negotiation at chipset layer). Antenna diversity may remain disabled and the ranging interval may remain at its default value. The Tx power can be increased to its maximum or may remain at its default value.

In another example embodiment, when one of the finder device or target device has no cellular capabilities and power limitations (e.g., peripheral devices with limited battery power), and the other device is a mobile phone, antenna diversity can be enabled for the mobile phone and the ranging interval can be increased. For example, a ranging interval of 120 ms can be used. Antenna diversity can be enabled for the mobile phone, which is triggered when the location determining application is opened.

In another example embodiment, when the finder device is in motion, the data rate may be adjusted based on whether the finder device is moving towards the target device or away from the target device. If the finder device is moving towards the target device, the data rate may be higher, e.g., 1 Mbps. If the finder device is moving away from the target device, the data rate may be lower, e.g., 256 kbps.

FIG. 6 shows an example network arrangement 600 according to various example embodiments. The example network arrangement 600 include UEs 610, 612. The UEs 610, 612 may be any type of electronic component that is configured to communicate via a network, e.g., mobile phones, tablet computers, desktop computers, smartphones, embedded devices, wearables (e.g., HMD, AR glasses, etc.), Internet of Things (IoT) devices, etc. An actual network arrangement may include any number of UEs being used by any number of users. Thus, the example of two UEs 610, 612 is merely provided for illustrative purposes.

The UEs 610, 612 may communicate directly with one or more networks. In the example of the network configuration 600, the networks with which the UEs 610, 612 may wirelessly communicate are a 5G NR radio access network (5G NR-RAN) 620, an LTE radio access network (LTE-RAN) 622 and a wireless local access network (WLAN) 624. However, the UEs 610, 612 may also communicate with other types of networks, e.g., a wide area network (WAN), and the UEs 610, 612 may also communicate with networks over a wired connection. Therefore, the UEs 610, 612 may include a 5G NR chipset to communicate with the 5G NR-RAN 620, an LTE chipset to communicate with the LTE-RAN 622 and an ISM chipset to communicate with the WLAN 624.

The 5G NR-RAN 620 and the LTE-RAN 622 may be portions of cellular networks that may be deployed by a network carrier (e.g., Verizon, AT&T, T-Mobile, etc.). These networks 620, 622 may include, for example, cells or base stations (Node Bs, evolved NodeBs (eNodeBs), Home eNBs (HeNBs), next generation Node Bs (gNBs), gNodeBs, macrocells, microcells, small cells, femtocells, etc.) that are configured to send and receive traffic from UEs that are equipped with the appropriate cellular chip set. The WLAN 624 may include any type of wireless local area network (WiFi, Hot Spot, IEEE 802.11x networks, etc.).

The UEs 610, 612 may connect to the 5G NR-RAN via the gNB 620A or the gNB 620B. Reference to two gNBs 620A, 620B is merely for illustrative purposes. The example embodiments may apply to any appropriate number of gNBs. The UEs 610, 612 may also connect to the LTE-RAN 622 via the eNBs 622A, 622B. Any association procedure may be performed for the UEs 610, 612 to connect to the 5G NR-RAN 620 and the LTE-RAN 622. For example, as discussed above, the 5G NR-RAN 620 and the LTE-RAN 622 may be associated with a particular cellular provider where the UEs 610, 612 and/or the user thereof has a contract and credential information (e.g., stored on a SIM card). Upon detecting the presence of the 5G NR-RAN 620, the UEs 610, 612 may transmit the corresponding credential information to associate with the 5G NR-RAN 620. More specifically, the UEs 610, 612 may associate with a specific base station (e.g., the gNB 620A of the 5G NR-RAN 620, the eNB 622A of the LTE-RAN 622).

In addition to the networks 620, 622 and 624 the network arrangement 600 also includes a cellular core network 630, the Internet 640, an IP Multimedia Subsystem (IMS) 650, and a network services backbone 660. The cellular core network 630 may be considered to be the interconnected set of components that manages the operation and traffic of the cellular network. The cellular core network 630 also manages the traffic that flows between the cellular network and the Internet 640. The IMS 650 may be generally described as an architecture for delivering multimedia services to the UEs 610, 612 using the IP protocol. The IMS 650 may communicate with the cellular core network 630 and the Internet 640 to provide the multimedia services to the UEs 610, 612. The network services backbone 660 is in communication either directly or indirectly with the Internet 640 and the cellular core network 630. The network services backbone 660 may be generally described as a set of components (e.g., servers, network storage arrangements, etc.) that implement a suite of services that may be used to extend the functionalities of the UEs 610, 612 in communication with the various networks.

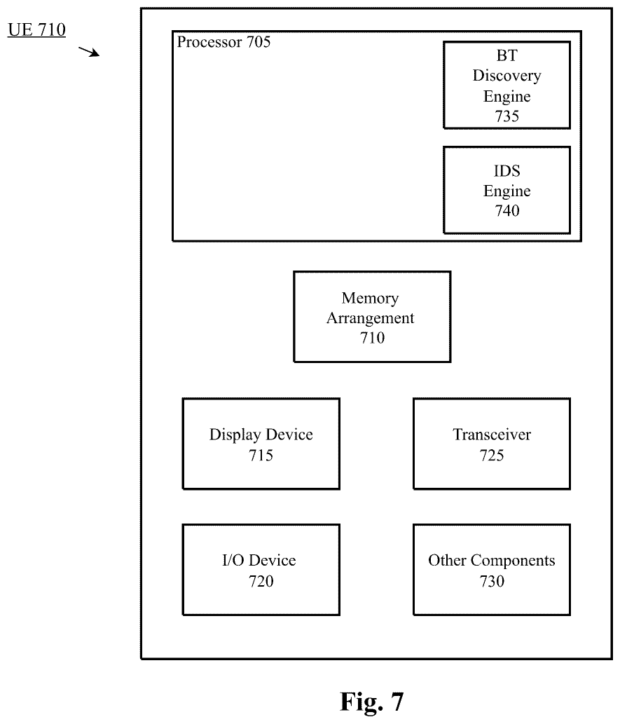

FIG. 7 shows an example UE 610 according to various example embodiments. The UE 610 will be described with regard to the network arrangement 600 of FIG. 6. The UE 610 may include a processor 705, a memory arrangement 710, a display device 715, an input/output (I/O) device 720, a transceiver 725 and other components 730. The other components 730 may include, for example, an audio input device, an audio output device, a power supply, a data acquisition device, ports to electrically connect the UE 610 to other electronic devices, etc.

The processor 705 may be configured to execute a plurality of engines of the UE 610. For example, the engines may include a Bluetooth discovery engine 735 for performing various operations related to performing a Bluetooth discovery operation to trigger UWB ranging, as described above. The engines may also include an IDS (Internet Discovery Service) engine 740 for performing various operations related to performing an Internet-based discovery operation to trigger UWB ranging, as described above.

The above referenced engines 735, 740 being an application (e.g., a program) executed by the processor 705 is provided merely for illustrative purposes. The functionality associated with the engines 735, 740 may also be represented as a separate incorporated component of the UE 610 or may be a modular component coupled to the UE 610, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 705 is split among two or more processors such as a baseband processor and an applications processor. The example embodiments may be implemented in any of these or other configurations of a UE.

The memory arrangement 710 may be a hardware component configured to store data related to operations performed by the UE 610. The display device 715 may be a hardware component configured to show data to a user while the I/O device 720 may be a hardware component that enables the user to enter inputs. The display device 715 and the I/O device 720 may be separate components or integrated together such as a touchscreen.

The transceiver 725 may be a hardware component configured to establish a wireless connection with one or more networks or with one or more other wireless communication devices. The transceiver may be configured for operating using more than one radio access technology. Accordingly, the transceiver 725 may operate on a variety of different frequencies or channels (e.g., set of consecutive frequencies) to communicate with the networks and/or other wireless communication devices. The transceiver may be configured for operating using a short-range communication protocol, e.g., Bluetooth. The transceiver 725 may include separate transceiver circuitry for each of a respective type of wireless connection, radio access technology, and/or range of frequencies of operation. The transceiver may comprise transceiver circuitry configured for operating using Bluetooth communication. The transceiver 725 includes circuitry configured to transmit and/or receive signals (e.g., control signals, data signals). Such signals may be encoded with information implementing any one of the methods described herein. The processor 705 may be operably coupled to the transceiver 725 and configured to receive from and/or transmit signals to the transceiver 725. The processor 705 may be configured to encode and/or decode signals for implementing any one of the methods described herein.

### EXAMPLES

In a first example, a method, comprising initiating an operation to locate a target device, determining one or more metrics related to Bluetooth congestion, determining transmission parameters for a Bluetooth discovery operation based on the one or more metrics, generating, for transmission, Bluetooth discovery signals with the determined transmission parameters and triggering an ultra-wideband (UWB) ranging operation when a Bluetooth discovery response from the target device is detected.

In a second example, the method of the first example, wherein the transmission parameters for the Bluetooth discovery operation include a transmit power, a data rate, a ranging interval or whether antenna diversity is enabled or disabled.

In a third example, the method of the second example, wherein, when the one or more metrics indicate a non-congested Bluetooth environment, a first transmit power is used for the Bluetooth discovery operation, and when the one or more metrics indicate a congested Bluetooth environment, a second transmit power greater than the first transmit power is used for the Bluetooth discovery operation.

In a fourth example, the method of the third example, further comprising determining a country code by core telephony and based on the country code, determining the second transmit power.

In a fifth example, the method of the fourth example, wherein the first transmit power comprises 7.5 dBm and the second transmit power comprises 15 dBm when the country code indicates United States.

In a sixth example, the method of the fifth example, wherein the first transmit power comprises 7.5 dBm and the second transmit power comprises 12 dBm when the country code indicates Europe.

In a seventh example, the method of the second example, wherein, when the one or more metrics indicate a non-congested Bluetooth environment, a first data rate is used for the Bluetooth discovery operation, when the one or more metrics indicate a first degree of Bluetooth congestion, a second data rate less than the first data rate is used for the Bluetooth discovery operation, and, when the one or more metrics indicate a second degree of Bluetooth congestion greater than the first degree of Bluetooth congestion, a third data rate less than the second data rate is used for the Bluetooth discovery operation.

In an eighth example, the method of the seventh example, wherein the first data rate comprises 2 Mbps, the second data rate comprises 1 Mbps, and the third data rate comprises 256 kbps.

In a ninth example, the method of the second example, wherein, when the one or more metrics indicate a non-congested Bluetooth environment, a first ranging interval is used for the Bluetooth discovery operation, when the one or more metrics indicate a first degree of Bluetooth congestion, a second ranging interval greater than the first ranging interval is used for the Bluetooth discovery operation, and when the one or more metrics indicate a second degree of Bluetooth congestion greater than the first degree of Bluetooth congestion, a third ranging interval greater than the second ranging interval is used for the Bluetooth discovery operation.

In a tenth example, the method of the ninth example, wherein the first ranging interval comprises 10 ms, the second ranging interval comprises 15 ms, and the third ranging interval comprises 30 ms.

In an eleventh example, the method of the second example, wherein, when the one or more metrics indicate a non-congested Bluetooth environment, antenna diversity is disabled for the Bluetooth discovery operation, and when the one or more metrics indicate a congested Bluetooth environment, antenna diversity is enabled for the Bluetooth discovery operation.

In a twelfth example, the method of the first example, wherein the one or more metrics includes a crowd density metric determined by locally scanning a number of Bluetooth devices within range of a user equipment (UE) comprising the apparatus.

In a thirteenth example, the method of the twelfth example, wherein, when the crowd density metric indicates a non-congested Bluetooth environment, first transmission parameters comprising a first transmission power, a first data rate, a first ranging interval, and disabled antenna diversity are used for the Bluetooth discovery operation, when the crowd density metric indicates a first degree of Bluetooth congestion, second transmission parameters comprising a second transmission power greater than the first transmission power, a second data rate less than the first data rate, a second ranging interval greater than the first ranging interval, or enabled antenna diversity are used for the Bluetooth discovery operation, and when the crowd density metric indicates a second degree of Bluetooth congestion greater than the first degree of Bluetooth congestion, a third data rate less than the second data rate or a third ranging interval greater than the second ranging interval are used for the Bluetooth discovery operation.

In a fourteenth example, the method of the thirteenth example, wherein the non-congested Bluetooth environment is associated with less than 100 Bluetooth devices within range of the UE, the first degree of Bluetooth congestion is 250 Bluetooth devices within range of the UE, and the second degree of Bluetooth congestion is 500 Bluetooth devices within range of the UE.

In a fifteenth example, the method of the first example, wherein the one or more metrics includes a visibility metric determined by analyzing a line of sight (LoS) link margin time series or a no line of sight (nLoS) link margin time series.

In a sixteenth example, a processor configured to perform any of the methods of the first through fifteenth examples.

In a seventeenth example, a user equipment (UE) configured to perform any of the methods of the first through fifteenth examples.

In an eighteenth example, a method, comprising initiating an operation to locate a target device, determining whether cellular or wireless network coverage is available, when cellular or wireless network coverage is available, generating, for transmission at a first transmit power, Bluetooth discovery signals, when cellular or wireless network coverage is not available, generating, for transmission at a second transmit power, the Bluetooth discovery signals, wherein the second transmit power is greater than the first transmit power and triggering an ultrawideband (UWB) ranging operation when a Bluetooth discovery response from the target device is detected.

In a nineteenth example, a processor configured to perform the method of the eighteenth example.

In a twentieth example, a user equipment (UE) configured to perform the method of the eighteenth example.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
initiate an operation to locate a target device;
determine one or more metrics related to Bluetooth congestion;
determine transmission parameters for a Bluetooth discovery operation based on the one or more metrics;
generate, for transmission, Bluetooth discovery signals with the determined transmission parameters; and
trigger an ultra-wideband (UWB) ranging operation when a Bluetooth discovery response from the target device is detected.

2. The apparatus of claim 1, wherein the transmission parameters for the Bluetooth discovery operation include a transmit power, a data rate, a ranging interval or whether antenna diversity is enabled or disabled.

3. The apparatus of claim 2, wherein, when the one or more metrics indicate a non-congested Bluetooth environment, a first transmit power is used for the Bluetooth discovery operation, and
when the one or more metrics indicate a congested Bluetooth environment, a second transmit power greater than the first transmit power is used for the Bluetooth discovery operation.

4. The apparatus of claim 3, wherein the processing circuitry is further configured to:
determine a country code by core telephony; and
based on the country code, determine the second transmit power.

5. The apparatus of claim 4, wherein the first transmit power comprises 7.5 dBm and the second transmit power comprises 15 dBm when the country code indicates United States.

6. The apparatus of claim 5, wherein the first transmit power comprises 7.5 dBm and the second transmit power comprises 12 dBm when the country code indicates Europe.

7. The apparatus of claim 2, wherein, when the one or more metrics indicate a non-congested Bluetooth environment, a first data rate is used for the Bluetooth discovery operation,
when the one or more metrics indicate a first degree of Bluetooth congestion, a second data rate less than the first data rate is used for the Bluetooth discovery operation, and
when the one or more metrics indicate a second degree of Bluetooth congestion greater than the first degree of Bluetooth congestion, a third data rate less than the second data rate is used for the Bluetooth discovery operation.

8. The apparatus of claim 7, wherein the first data rate comprises 2 Mbps, the second data rate comprises 1 Mbps, and the third data rate comprises 256 kbps.

9. The apparatus of claim 2, wherein, when the one or more metrics indicate a non-congested Bluetooth environment, a first ranging interval is used for the Bluetooth discovery operation,
when the one or more metrics indicate a first degree of Bluetooth congestion, a second ranging interval greater than the first ranging interval is used for the Bluetooth discovery operation, and
when the one or more metrics indicate a second degree of Bluetooth congestion greater than the first degree of Bluetooth congestion, a third ranging interval greater than the second ranging interval is used for the Bluetooth discovery operation.

10. The apparatus of claim 9, wherein the first ranging interval comprises 10 ms, the second ranging interval comprises 15 ms, and the third ranging interval comprises 30 ms.

11. The apparatus of claim 2, wherein, when the one or more metrics indicate a non-congested Bluetooth environment, antenna diversity is disabled for the Bluetooth discovery operation, and
when the one or more metrics indicate a congested Bluetooth environment, antenna diversity is enabled for the Bluetooth discovery operation.

12. The apparatus of claim 1, wherein the one or more metrics includes a crowd density metric determined by locally scanning a number of Bluetooth devices within range of a user equipment (UE) comprising the apparatus.

13. The apparatus of claim 12, wherein, when the crowd density metric indicates a non-congested Bluetooth environment, first transmission parameters comprising a first transmission power, a first data rate, a first ranging interval, and disabled antenna diversity are used for the Bluetooth discovery operation,
when the crowd density metric indicates a first degree of Bluetooth congestion, second transmission parameters comprising a second transmission power greater than the first transmission power, a second data rate less than the first data rate, a second ranging interval greater than the first ranging interval, or enabled antenna diversity are used for the Bluetooth discovery operation, and
when the crowd density metric indicates a second degree of Bluetooth congestion greater than the first degree of Bluetooth congestion, a third data rate less than the second data rate or a third ranging interval greater than the second ranging interval are used for the Bluetooth discovery operation.

14. The apparatus of claim 13, wherein the non-congested Bluetooth environment is associated with less than 100 Bluetooth devices within range of the UE, the first degree of Bluetooth congestion is 250 Bluetooth devices within range of the UE, and the second degree of Bluetooth congestion is 500 Bluetooth devices within range of the UE.

15. The apparatus of claim 1, wherein the one or more metrics includes a visibility metric determined by analyzing a line of sight (LoS) link margin time series or a no line of sight (nLoS) link margin time series.

16. An apparatus comprising processing circuitry configured to:
initiate an operation to locate a target device;
determine whether cellular or wireless network coverage is available;
when cellular or wireless network coverage is available, generate, for transmission at a first transmit power, Bluetooth discovery signals;
when cellular or wireless network coverage is not available, generate, for transmission at a second transmit power, the Bluetooth discovery signals, wherein the second transmit power is greater than the first transmit power; and
trigger an ultrawideband (UWB) ranging operation when a Bluetooth discovery response from the target device is detected.
